(19) United States
(12) Patent Application Publication
(10) Pub. No.: US 2006/0222018 A1
(43) Pub. Date: Oct. 5, 2006

(54) Method and apparatus for determining delays of links between switches

(75) Inventor: Govinda Nallappa Rajan, Huizen (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/093,515

(22) Filed: Mar. 30, 2005

(51) Int. Cl. H04J 3/06

(52) U.S. Cl. 370/508

(57) ABSTRACT

The invention comprises a method and apparatus for determining a delay of a link between switches. Specifically, the method comprises determining a plurality of intra-switch router delays by determining an intra-switch router delay between a pair of routers for each pair of routers in a plurality of pairs of routers wherein each of the pairs of routers is connected to one of the first switch and the second switch, determining a plurality of inter-switch router delays by determining an inter-switch router delay between a pair of routers for each pair of routers in a plurality of pairs of routers wherein each of the pairs of routers comprises a first router and a second router, and computing the average delay of the link between the first switch and the second switch using the plurality of intra-switch router delays and the plurality of inter-switch router delays.

### FIELD OF THE INVENTION

The invention relates to the field of communication networks and, more specifically, to computation of delays associated with links between switches.

### BACKGROUND OF THE INVENTION

In general, there are numerous situations in which knowledge of the average delay of a link between switches (e.g., Ethernet switches) is required. For example, such knowledge may be required for planning network upgrades designed to keep network delays within service level agreements (SLAs) agreed upon by a service provider and service provider customers. Similarly, such knowledge may be required for locating the cause of network service problems (e.g., for determining whether service degradation is caused by a problem located within the service provider network or located within the customer network). Unfortunately, no methods currently exist for determining average delays associated with links between certain types of switches (e.g., Ethernet switches).

### SUMMARY OF THE INVENTION

Various deficiencies in the prior art are addressed through the invention of a method and apparatus for determining a delay of a link between switches. Specifically, a method according to one embodiment of the invention comprises determining a plurality of intra-switch router delays by determining an intra-switch router delay between a pair of routers for each pair of routers in a plurality of pairs of routers wherein each of the pairs of routers is connected to one of a first switch and a second switch, determining a plurality of inter-switch router delays by determining an inter-switch router delay between a pair of routers for each pair of routers in a plurality of pairs of routers wherein each of the pairs of routers comprises a first router and a second router (where the first router is connected to the first switch and the second router is connected to the second switch), and computing the average delay of the link between the first switch and the second switch using the plurality of intra-switch router delays and the plurality of inter-switch router delays.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communications network architecture;

FIG. 2 depicts a flow diagram of a method according to one embodiment of the invention; and

FIG. 3 depicts a high-level block diagram of a general purpose computer suitable for use in performing the functions described herein.

To facilitate understanding, identical reference numerals have been used, where possible, to designate identical elements that are common to the figures.

### DETAILED DESCRIPTION OF THE INVENTION

The invention is discussed in the context of a communications network architecture comprising a plurality of Ethernet switches and an associated plurality of routers; however, the methodology of the invention can readily be applied to other networks and network topologies. In general, the present invention enables determination of an average delay of a link between a first switch and a second switch. As such, the present invention enables service providers to perform various activities requiring knowledge of the average delays of links between switches (e.g., planning network upgrades, locating network service problems, and like activities). Although described herein with respect to Ethernet switches, the methodologies of the present invention may be used for determining average delays associated with links between various other switches (e.g., switches lacking link delay determination capabilities).

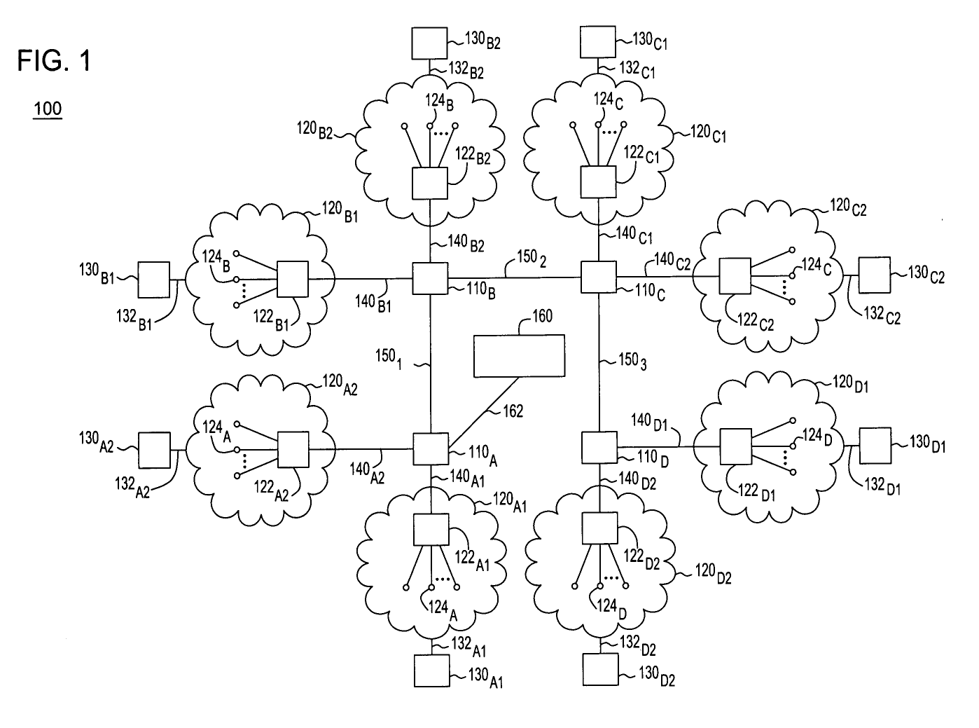

FIG. 1 depicts a high-level block diagram of a communications network architecture. Specifically, communications network architecture 100 of FIG. 1 comprises a plurality of Ethernet switches (ESs) 110_{A}-110_{D} (collectively, ESs 110) and a link delay computation system (LDCS) 160. As depicted in FIG. 1, ES 110_{A}communicates with a plurality of networks 120_{A1}-120_{A2} (collectively, networks 120_{A}), ES 110_{B} communicates with a plurality of networks 120_{B1}-120_{B2} (collectively, networks 120_{B}), ES 110_{C} communicates with a plurality of networks 120_{C1}-120_{C2} (collectively, networks 120_{C}) and ES 110_{D} communicates with a plurality of networks 120_{D1}-120_{D2} (collectively, networks 120_{D}).

As depicted in FIG. 1, the ESs 110 communicate via a plurality of Ethernet links 150₁-150₃ (collectively, ELs 150). More specifically, ES 110_{A} and ES 110_{B} communicate via EL 150₁, ES 110_{B} and ES 110_{C} communicate via EL 150₂, and ES 110_{C} and ES 110_{D} communicate via EL 150₃. Furthermore, ES 110_{A} communicates with the networks 120_{A} via a respective plurality of communication links (CLs) 140_{A1}-140_{A2} (collectively, CLs 140_{A}), ES 110_{B} communicates with the networks 120_{B} via a respective plurality of CLs 140_{B1}-140_{B2} (collectively, CLs 140_{B}), ES 110_{C} communicates with the networks 120_{C} via a respective plurality of CLs 140_{C1}-140_{C2} (collectively, CLs 140_{C}), and ES 110_{D} communicates with the networks 120_{D} via a respective plurality of CLs 140_{D1}-140_{D2} (collectively, CLs 140_{D}).

As depicted in FIG. 1, networks 120_{A} comprise a respective plurality of routers 122_{A1}-122_{A2} (collectively, routers 122_{A}), networks 120_{B} comprise a respective plurality of routers 122_{B1}-122_{B2} (collectively, routers 122_{B}), networks 120_{C} comprise a respective plurality of routers 122_{C1}-122_{C2} (collectively, routers 122_{C}), and networks 120_{D} comprise a respective plurality of routers 122_{D1}-122_{D2} (collectively, routers 122_{D}). The routers 122_{A}-122_{D} are collectively denoted as routers 122. In one embodiment, at least a portion of the routers 122 are operable for determining intra-switch rooter delays, inter-switch router delays, and the like, as described herein. The routers 122_{A}-122_{D} communicate with respective pluralities of user terminals (UTs) 124_{A}-124_{D} (collectively, UTs 124). In general, the UTs 124 comprise network devices such as phones (e.g., IP phones), computers, and the like.

As depicted in FIG. 1, networks 120_{A1} and 120_{A2} communicate with respective software probes (SPs) 130_{A1} and 130_{A2} (collectively, SPs 130_{A}) via communication links (CLs) 132_{A1} and 132_{A2} (collectively, CLs 132_{A}). Similarly, networks 120_{B1} and 120_{B2} communicate with respective SPs 130_{B1} and 130_{B2} (collectively, SPs 130_{B}) via CLs 132_{B}, and 132_{B2} (collectively, CLs 132_{B}). Similarly, networks 120_{C1} and 120_{C2} communicate with respective SPs 130_{C1} and 130_{C2} (collectively, SPs 130_{C}) via CLs 132_{C1} and 132_{C2} (collectively, CLs 132_{C}). Similarly, networks 120_{D1} and 120_{D2} communicate with respective SPs 130_{D1} and 130_{D2} (collectively, SPs 130_{D}) via CLs 132_{D1}-132_{D2} (collectively, CLs 132_{D}). The SPs 130_{A}-130_{D} are collectively denoted as SPs 130. The CLs 132_{A}-132_{D} are collectively denoted as CLs 132.

In general, the SPs 130 comprise modules operable for determining delays between various combinations of the routers 122. In one embodiment, the SPs 130 comprise systems operable for receiving link delay determination instructions from LDCS 160, determining intra-switch router delays and inter-switch router delays, transmitting intra-switch router delay data and inter-switch router delay data to LDCS 160 for further processing, and performing like functions. In one embodiment, SPs 130 perform at least a portion of the methodologies of the present invention. In another embodiment (not depicted), the SPs 130 may be implemented as respective portions of the routers 122 (e.g., SP 130_{A1} may be implemented as a module on router 122_{A1}). Similarly, at least a portion of the functionality of the SPs 130 may be implemented as a portion of LDCS 160.

In one embodiment, LDCS 160 performs at least a portion of the methodologies of the present invention as described herein. For example, in one embodiment, LDCS 160 computes intra-switch router delays, inter-switch router delays, Ethernet link delays, and the like. In another embodiment (not depicted), multiple LDCSs may be utilized for performing the methodologies of the present invention. Furthermore, although depicted as a standalone system, in one embodiment, at least a portion of the functionality of LDCS 160 may be distributed across at least one of: at least one of the routers 122, at least one of the SPs 130, and the like. As depicted in FIG. 1, LDCS 160 communicates with ES 110_{A} via associated communication link (CL) 162. Although depicted as communicating with ES 110_{A}, LDCS 160 may communicate with various combinations of the ESs 110. Although not depicted, in one embodiment, LDCS 160 communicates with ES 110_{A} via at least one associated router.

Although depicted as comprising specific numbers of ESs 110, networks 120, routers 122, UTs 124, SPs 130, CLs 132, CLs 140, ELs 150, LDCSs 160 and CLs 162, those skilled in the art will appreciate that fewer or more ESs 110, networks 120, routers 122, UTs 124, SPs 130, CLs 132, CLs 140, ELs 150, LDCSs 160 and CLs 162 may be used. Similarly, the ESs 110, networks 120, routers 122, UTs 124, SPs 130, CLs 132, CLs 140, ELs 150, LDCSs 160 and CLs 162 may be deployed in various other configurations. Furthermore, various other switches, networks, routers, and like devices, as well as associated communication links, may be utilized in support of the methodologies of the present invention.

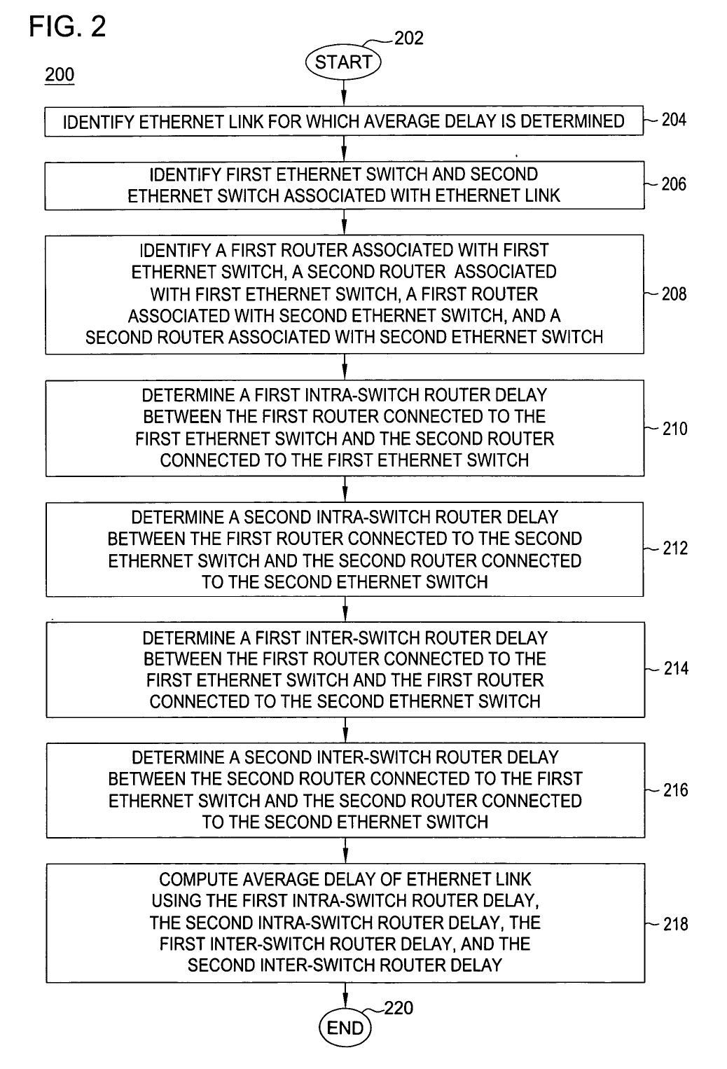

FIG. 2 depicts a flow diagram of a method according to one embodiment of the invention. Specifically, method 200 of FIG. 2 comprises a method for determining an average delay of a link between a first Ethernet switch and a second Ethernet switch. Although a portion of the steps are depicted as being performed serially, those skilled in the art will appreciate that at least a portion of the steps of method 200 may be performed contemporaneously, as well as in a different order than presented in FIG. 2. The method 200 is entered at step 202 and proceeds to step 204.

At step 204, an Ethernet link for which an average delay is determined is identified. In one embodiment, identification of an Ethernet link is performed manually by a user. For example, a user may initiate determination of an average delay associated with an Ethernet link via a user interface associated with LDCS 160. In another embodiment, identification of an Ethernet link is performed automatically in response to at least one instruction received from a remote system. For example, a network alarm monitoring system (not depicted) initiates a request to LDCS 160 for determining an average delay associated with a link between Ethernet switches. For the purposes of clarity by way of example, assume that EL 150₁ is identified as the Ethernet link for which an average delay is determined.

At step 206, a first Ethernet switch associated with the identified Ethernet link and a second Ethernet switch associated with the identified Ethernet link are identified. In one embodiment, identification of the first Ethernet switch and the second Ethernet switch is performed using network topology information. For example, identification of the first and second Ethernet switches is performed by LDCS 160 using locally stored network topology information. In continuation of the above example, the first and second Ethernet switches comprise ESs 110_{A} and 110_{B}, respectively.

At step 208, a first router associated with the first Ethernet switch, a second router associated with the first Ethernet switch, a first router associated with the second Ethernet switch, and a second router associated with the second Ethernet switch are identified. In one embodiment, in which more than two routers are associated with an Ethernet switch, the first router and second router associated with the Ethernet switch are identified using at least one of a plurality of methods (e.g., using at least one algorithm, randomly, and the like). In continuation of the above example, the first and second routers associated with the first Ethernet switch (i.e., ES 110_{A}) comprise routers 122_{A1} and 122_{A2}, respectively. Similarly, the first router and second router associated with the second Ethernet switch (i.e., ES 110_{B}) comprise routers 122_{B1} and 122_{B2}, respectively.

At step 210, a first intra-switch router delay between the first router connected to the first Ethernet switch and the second router connected to the first Ethernet switch is determined. In continuation of the above example, the first intra-switch router delay between router 122_{A1} and router 122_{A2} is determined. At step 212, a second intra-switch router delay between the first router connected to the second Ethernet switch and the second router connected to the second Ethernet switch is determined. In continuation of the above example, the second intra-switch router delay between router 122_{B1} and router 122_{B2} is determined.

At step 214, a first inter-switch router delay between the first router connected to the first Ethernet switch and the first router connected to the second Ethernet switch is determined. In continuation of the above example, the first inter-switch router delay between router 122_{A1} and router 122_{B1} is determined. At step 216, a second inter-switch router delay between the second router connected to the first Ethernet switch and the second router connected to the second Ethernet switch is determined. In continuation of the above example, the second inter-switch router delay between router 122_{A2} and router 122_{B2} is determined.

Although described herein as a delay between the first router connected to the first Ethernet switch and the first router connected to the second Ethernet switch, in another embodiment, the first inter-switch router delay comprises a delay between the first router connected to the first Ethernet switch and the second router connected to the second Ethernet switch. Similarly, although described as a delay between the second router connected to the first Ethernet switch and the second router connected to the second Ethernet switch, in this embodiment, the second inter-switch router delay may comprise a delay between the second router connected to the first Ethernet switch and the first router connected to the second Ethernet switch.

In general, determination of the intra-switch router delays and inter-switch router delays and inter-switch router delays may be performed using at least one of a multitude of methods of determining delays between routers, as known in the art. In one embodiment, for example, intra-switch router delays and inter-switch router delays are determined using ping commands, trace commands, and like commands for determining delay between routers. The use of ping commands and trace commands for determining delays between routers is well known in the art.

In one embodiment, LDCS 160 initiates determination of intra-switch router delays and inter-switch router delays. In one such embodiment, LDCS 160 transmits delay determination instructions to the associated SPs 130. For example, LDCS 160 transmits ping instructions to the SPs 130 associated with the first router and second router associated with the first Ethernet switch and the first router and second router associated with the second Ethernet switch. Upon receiving the delay determination instructions, the SPs 130 initiate various commands for determining the delays requested by LDCS 160. For example, the SPs 130 initiate ping commands, trace commands, and the like. In one embodiment, the SPs 130 obtain the command results required for determining the intra-switch router delays and inter-switch router delays.

In another embodiment, the SPs 130 are preconfigured to periodically obtain the raw delay data required for determining intra-switch router delays and inter-switch router delays between various pairs of routers 122. In one embodiment, for example, the SPs 130 are configured to periodically initiate ping commands, trace commands, and the like, and to obtain the associated command results. In another embodiment, for example, the SPs 130 may be configured to instruct the associated routers 122 to initiate ping commands, trace commands, and the like once each millisecond, one each second, and the like.

In one embodiment, LDCS 160 obtains raw delay data (e.g., command results) from the SPs 130 and processes the raw delay data for determining intra-switch router delays and the inter-switch router delays. Similarly, in another embodiment, the SPs 130 periodically transmit raw delay data to LDCS 160, and LDCS 160 processes the raw delay data for determining intra-switch router delays and inter-switch router delays. For example, raw delay data may comprise various ping command results, trace command results, and like delay data which may be processed for determining intra-switch and inter-switch router delays.

In one embodiment, the SPs 130 process raw delay data received from the associated routers 122 in order to determine intra-switch router delays and inter-switch router delays. In one such embodiment, LDCS 160 retrieves the intra-switch router delays and inter-switch router delays from the SPs 130. Similarly, in another such embodiment, the SPs 130 transmit the intra-switch router delays and the inter-switch router delays to LDCS 160. In one such embodiment, the SPs 130 periodically transmit the intra-switch router delays and inter-switch router delays to LDCS 160.

In continuation of the above example, SP 130_{A1} initiates a ping command to SP 130_{A2} for determining the first intra-switch router delay between router 122_{A1} and router 122_{A2}. Similarly, SP 130_{B1} initiates a ping command to SP 130_{B2} for determining the second intra-switch router delay between router 122_{B1} and router 122_{B2}. As such, the first intra-switch router delay comprises the delay associated with CLs 140_{A1} and 140_{A2}. Similarly, the second intra-switch router delay comprises the delay associated with CLs 140_{B1} and 140_{B2}. Although described herein as being initiated by SPs 130_{A1} and 130_{B1}, those skilled in the art will appreciate that SPs 130_{A2} and 130_{B2} may initiate the respective ping commands for determining the first intra-switch router delay and the second intra-switch router delay.

In further continuation of the above example, SP 130_{A1} initiates a ping command to SP 130_{B1} for determining the first inter-switch router delay between router 122_{A1} and router 122_{B1}. Similarly, SP 130_{A2} initiates a ping command to SP 130_{B2} for determining the second inter-switch router delay between router 122_{A2} and router 122_{B2}. Although described herein as being initiated by SPs 130_{A1} and 130_{A2}, those skilled in the art will appreciate that SPs 130_{B1} and 130_{B2} may initiate the respective ping commands for determining the first inter-switch router delay and the second inter-switch router delay.

At step 218, the average delay of the Ethernet link between the first Ethernet switch and the second Ethernet switch is computed using the first intra-switch router delay, the second intra-switch router delay, the first inter-switch router delay, and the second inter-switch router delay. In one embodiment, the average delay of the Ethernet link between the first Ethernet switch and the second Ethernet switch is computed according to the following equation: [(D1+D2)−(D3+D4)]/2. In this equation, D1 comprises the first inter-switch router delay, D2 comprises the second inter-switch router delay, D3 comprises the first intra-switch router delay, and D4 comprises the second intra-switch router delay. The method 200 then proceeds to step 220, where the method 200 ends.

In continuation of the above example, the average delay of EL 150₁ between ES 110_{A} and ES 110_{B} is computed. As described herein, the average delay of EL 150₁ is computed using the first intra-switch router delay between router 122_{A1} and 122_{A2}, the second intra-switch router delay between router 122_{B1} and router 122_{B2}, the first inter-switch router delay between router 122_{A1} and router 122_{B1}, and the second inter-switch router delay between router 122_{A2} and router 122_{B2}.

Although described herein as computing a delay associated with a link between directly connected Ethernet switches (illustratively, ES 110_{A} and ES 110_{B} directly connected via EL 150₁), those skilled in the art will appreciate that the methodologies of the present invention may be used for determining an average delay between a first Ethernet switch and second Ethernet switch connected via at least one additional Ethernet switch. For example, as depicted in FIG. 1, the average delay between ESs 110_{A} and 110_{C} (i.e., the combined average delay associated with EL 150₁ and EL 150₂) may be determined using the methodologies of the present invention.

In one such embodiment, the methodologies of the present invention are performed in a manner that renders the at least one intervening Ethernet switch transparent to the determination of the average delay between Ethernet switches. For example, in order to determine the average delay between ESs 110_{A} and 110_{C}, the methodology of the present invention is performed once for ESs 110_{A} and 110_{C}. In this embodiment, routers 122_{C1} and 122_{C2} replace routers 122_{B1} and 122_{B2}, respectively, and SPs 130_{C1} and 130_{C2} replace SPs 130_{B1} and 130_{B2}, respectively, for the purposes of determining the intra-switch router delays and the inter-switch router delays.

In another such embodiment, the methodology of the present invention may be repeated for each Ethernet link connecting the first Ethernet switch to the second Ethernet switch. For example, in order to determine the average delay between ESs 110_{A} and 110_{C}, the methodology of the present invention is performed a first time for determining the average delay between ESs 110_{A} and 110_{B} and is performed a second time for determining the average delay between ESs 110_{B} and 110_{C}. The average delay between ESs 110_{A} and 110_{B} is then determined by computing the average delay using the average delays associated with EL 150₁ and EL 150₂.

It is contemplated that at least a portion of the described functions may be combined into fewer functional elements/devices. Similarly, it is contemplated that the various functions may be performed by other functional elements, and that the various functions may be distributed across the various functional elements in a different manner. For example, at least a portion of the functionality described herein with respect to the SPs 130 may be implemented as a portion of the routers 122. Similarly, at least a portion of the functionality of the SPs 130 may be implemented as a portion of LDCS 160. Furthermore, at least a portion of the functionality described herein with respect to LDCS 160 may be distributed across a plurality of LDCSs, at least a portion of the routers 122, at least a portion of the SPs 130, and the like.

Although described herein with respect to computation of Ethernet link delays between Ethernet switches configured in a linear chain topology, those skilled in the art will appreciate that the methodology of the present invention may be used for determining delays associated with various other networks elements, network topologies, and the like. For example, the methodologies of the present invention may be used for determining average delays of links between switches connected in various other network topologies (e.g., hub-and-spoke, ring, bus, partial-mesh, full-mesh, and the like). Furthermore, the methodologies of the present invention may be used for determining delays associated with links between other types of switches (e.g., switches lacking link delay determination functionality).

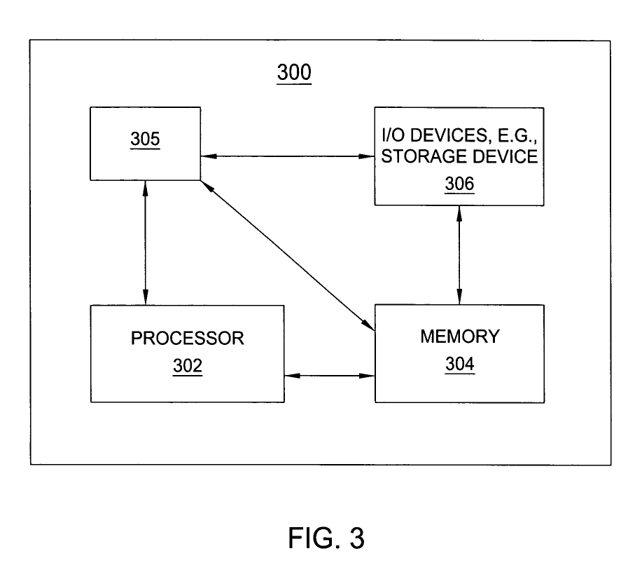

FIG. 3 depicts a high level block diagram of a general purpose computer suitable for use in performing the functions described herein. As depicted in FIG. 3, system 300 comprises a processor element 302 (e.g., a CPU), a memory 304, e.g., random access memory (RAM) and/or read only memory (ROM), a link delay computation module 305, and various input/output devices 306 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present link delay computation module or process 305 can be loaded into memory 304 and executed by processor 302 to implement the functions as discussed above. As such, the link delay computation process 305 (including associated data structures) of the present invention can be stored on a computer readable medium or carrier, e.g., RAM memory, magnetic or optical drive or diskette and the like.

Although various embodiments which incorporate the teachings of the present invention have been shown and described in detail herein, those skilled in the art can readily devise many other varied embodiments that still incorporate these teachings.

What is claimed is:

1. A method for determining a delay of a link between a first switch and a second switch, comprising:
determining a plurality of intra-switch router delays by determining an intra-switch router delay between a pair of routers for each pair of routers in a plurality of pairs of routers, wherein each of said pairs of routers is connected to one of: said first switch and said second switch;
determining a plurality of inter-switch router delays by determining an inter-switch router delay between a pair of routers for each pair of routers in a plurality of pairs of routers, wherein each of said pairs of routers comprises a first router and a second router, said first router connected to said first switch and said second router connection to said second switch; and
computing said delay of said link between said first switch and said second switch using said plurality of intra-switch router delays and said plurality of inter-switch router delays.

2. The method of claim 1, wherein said determining said plurality of intra-switch router delays comprises:
determining a first intra-switch router delay between a first router connected to said first switch and a second router connected to said first switch; and
determining a second intra-switch router delay between a first router connected to said second switch and a second router connected to said second switch.

3. The method of claim 1, wherein said determining said plurality of inter-switch router delays comprises:
determining a first inter-switch router delay between said first router connected to said first switch and said first router connected to said second switch; and
determining a second inter-switch router delay between said second router connected to said first switch and said second router connected to said second switch.

4. The method of claim 1, wherein:
said determining said plurality of intra-switch router delays comprises:
determining a first intra-switch router delay between a first router connected to said first switch and a second router connected to said first switch; and
determining a second intra-switch router delay between a first router connected to said second switch and a second router connected to said second switch; and
said determining said plurality of inter-switch router delays comprises:
determining a first inter-switch router delay between said first router connected to said first switch and said first router connected to said second switch; and
determining a second inter-switch router delay between said second router connected to said first switch and said second router connected to said second switch.

5. The method of claim 4, wherein said computing said delay of said link between said first switch and said second switch comprises:
computing said delay of said link between said first switch and said second switch using said first intra-switch router delay, said second intra-switch router delay, said first inter-switch router delay, and said second inter-switch router delay.

6. The method of claim 5, wherein said computing is performed according to an equation comprising [(D1+D2)−(D3+D4)]/2, wherein D1 comprises said first inter-switch router delay, D2 comprises said second inter-switch router delay, D3 comprises said first intra-switch router delay, and D4 comprises said second intra-switch router delay.

7. The method of claim 4, wherein each of said first intra-switch router delay, said second intra-switch router delay, said first inter-switch router delay, and said second inter-switch router delay is determined using at least one ping command.

8. The method of claim 1, wherein said first switch and said second switch are connected via at least one additional switch.

9. A computer readable medium storing a software program, that, when executed by a computer, causes the computer to perform a method comprising:
determining a plurality of intra-switch router delays by determining an intra-switch router delay between a pair of routers for each pair of routers in a plurality of pairs of routers, wherein each of said pairs of routers is connected to one of: a first switch and a second switch;
determining a plurality of inter-switch router delays by determining an inter-switch router delay between a pair of routers for each pair of routers in a plurality of pairs of routers, wherein each of said pairs of routers comprises a first router and a second router, said first router connected to said first switch and said second router connection to said second switch; and
computing said delay of said link between said first switch and said second switch using said plurality of intra-switch router delays and said plurality of inter-switch router delays.

10. The computer readable medium of claim 9, wherein said determining said plurality of intra-switch router delays comprises:
determining a first intra-switch router delay between a first router connected to said first switch and a second router connected to said first switch; and
determining a second intra-switch router delay between a first router connected to said second switch and a second router connected to said second switch.

11. The computer readable medium of claim 9, wherein said determining said plurality of inter-switch router delays comprises:
determining a first inter-switch router delay between said first router connected to said first switch and said first router connected to said second switch; and
determining a second inter-switch router delay between said second router connected to said first switch and said second router connected to said second switch.

12. The computer readable medium of claim 9, wherein:
said determining said plurality of intra-switch router delays comprises:
determining a first intra-switch router delay between a first router connected to said first switch and a second router connected to said first switch; and
determining a second intra-switch router delay between a first router connected to said second switch and a second router connected to said second switch; and
said determining said plurality of inter-switch router delays comprises:
determining a first inter-switch router delay between said first router connected to said first switch and said first router connected to said second switch; and
determining a second inter-switch router delay between said second router connected to said first switch and said second router connected to said second switch.

13. The computer readable medium of claim 12, wherein said computing said delay of said link between said first switch and said second switch comprises:
computing said delay of said link between said first switch and said second switch using said first intra-switch router delay, said second intra-switch router delay, said first inter-switch router delay, and said second inter-switch router delay.

14. The computer readable medium d of claim 13, wherein said computing is performed according to an equation comprising [(D1+D2)−(D3+D4)]/2, wherein D1 comprises said first inter-switch router delay, D2 comprises said second inter-switch router delay, D3 comprises said first intra-switch router delay, and D4 comprises said second intra-switch router delay.

15. The computer readable medium of claim 12, wherein each of said first intra-switch router delay, said second intra-switch router delay, said first inter-switch router delay, and said second inter-switch router delay is determined using at least one ping command.

16. The computer readable medium of claim 9, wherein said first switch and said second switch are connected via at least one additional switch.

17. A system for determining a delay of a link between a first switch and a second switch, comprising:
a plurality of switches, said plurality of switches comprising said first switch and said second switch in communication using said link;
a plurality of networks, each of said networks comprising at least one router in communication with one of: said first switch and said second switch;
a plurality of software probes associated with said respective plurality of networks, said plurality of software probes operable for:
determining a plurality of intra-switch router delays by determining an intra-switch router delay between a pair of routers for each pair of routers in a plurality of pairs of routers, wherein each of said pairs of routers is connected to one of: said first switch and said second switch;
determining a plurality of inter-switch router delays by determining an inter-switch router delay between a pair of routers for each pair of routers in a plurality of pairs of routers, wherein each of said pairs of routers comprises a first router and a second router, said first router connected to said first switch and said second router connection to said second switch; and
a system in communication with at least one switch in said plurality of switches, said system operable for computing said delay using said plurality of intra-switch router delays and said plurality of inter-switch router delays.

18. The system of claim 17, wherein said determining said plurality of intra-switch router delays comprises:
determining a first intra-switch router delay between a first router connected to said first switch and a second router connected to said first switch; and
determining a second intra-switch router delay between a first router connected to said second switch and a second router connected to said second switch.

19. The system of claim 17, wherein said determining said plurality of inter-switch router delays comprises:
determining a first inter-switch router delay between said first router connected to said first switch and said first router connected to said second switch; and
determining a second inter-switch router delay between said second router connected to said first switch and said second router connected to said second switch.

20. The system of claim 17, wherein said first switch and said second switch are connected via at least one additional switch.
